(19) United States
(12) Patent Application Publication
(10) Pub. No.: US 2007/0258250 A1
(43) Pub. Date: Nov. 8, 2007

(54) VEHICLE PART DESK LAMP

(76) Inventor: James W. Kime, Maysville, GA (US)

Correspondence Address: GEORGE R. REARDON, 3356 STATION COURT, LAWRENCVILLE, GA, 30044, US

(21) Appl. No.: 11/381,354

(22) Filed: May 2, 2006

(51) Int. Cl. F21S 8/08

(52) U.S. Cl. 362/410; 362/413

(57) ABSTRACT

A vehicle part themed desk lamp is described. In particular, the present invention relates to a desk lamp utilizing authentic or replica vehicular parts, such as an engine valve cover for the lamp shade and spark plug wiring connecting the desk lamp base to the lamp shade. Logos may be disposed on the vehicular parts.

### FIELD OF THE INVENTION

The present invention generally relates to the field of desk lamps. In particular, the present invention relates to a desk lamp utilizing authentic or replica vehicular parts.

### BACKGROUND OF THE INVENTION

There is a continuing need for devices that can be used as an advertising vehicle to promote brand names to the consumer through the use of brand recognizable shapes and logos. This is especially true in the automotive industry, the racing industry and other industries.

Traditionally apparel, e.g. shirts, caps, jackets, has been one of the vehicles of choice for promoting brand awareness. Additionally, pens, bags, portfolios, clocks, paperweights, etc. have also been used. In some cases desk lamps and wall lamps have been designed to meet this need.

Examples of those entities needing or wanting an automotive themed desk lamp include automotive dealers, automotive service managers, auto parts stores, race track vendors, auto restorers, auto magazines, race fans, hot rod TV shows, brand loyalists, mass merchants, and shade-tree mechanics.

U.S. patents that address this area include the following.

U.S. Pat. No. D152,390, issued to E. R. Brenner on Jan. 18, 1949, illustrates a nursery lamp in the shape of a car.

U.S. Pat. No. D288,725, issued to Nikolaus P. Fisher on Mar. 10, 1987, illustrates a decorative table lamp featuring a stick shift.

U.S. Pat. No. D308,113, issued to Leonard O. Lewis, Jr. on May 22, 1990, illustrates a decorative wall lamp featuring the front portion of a car.

U.S. Pat. No. D322,331, issued to Shintaro Tsuji on Dec. 10, 1991, illustrates a reading lamp in the shape of a race car.

U.S. Pat. No. D460,577, issued to Michael Pogroszewski on Jul. 16, 2002, illustrates a desk lamp with automobile spoiler motif, as well as dashboard dials.

U.S. Pat. No. D481,153, issued to Paul Douglas Wilson on Oct. 21, 2003, illustrates a fire truck lamp.

U.S. Pat. No. D473,334, issued to Eric P. Consor on Apr. 15, 2003, illustrates a cap-form lamp shade with sports logo.

While previous lamps have attempted to solve the problems that they addressed, none have utilized or disclosed a device for illumination that utilizes a valve cover for the lamp shade, spark plug wires for providing the wiring to the lamp and a logo.

Accordingly, there is a need for a desk lamp device which can be used to promote a brand in the automotive industry. It is desirable to have such a device be distinctive, unique, and appealing to customers of this industry. The present invention is particularly suited to address these needs in a manner not previously contemplated.

Therefore, a need exists for a desk lamp device with these attributes and functionalities. The desk lamp device according to embodiments of the invention substantially departs from the conventional concepts and designs of the prior art. It can be appreciated that there exists a continuing need for a new and improved desk lamp which can be used commercially for promoting a brand within the automotive industry. In this regard, the present invention substantially fulfills these objectives.

The foregoing information reflect the state of the art of which the inventor is aware and is tendered with a view toward discharging the inventor's acknowledged duty of candor in disclosing information that may be pertinent to the patentability of the present invention. It is respectfully stipulated, however, that the foregoing information do not teach or render obvious, singly or when considered in combination, the inventor's claimed invention.

### BRIEF SUMMARY OF THE INVENTION

The general purpose of the present invention, which will be described subsequently in greater detail, is to provide a desk lamp device. In particular, the present invention relates to a desk lamp that utilizes an easily recognized vehicle part, e.g., a valve cover, as a lamp shade. The vehicle part may be from an automobile, a truck, a boat, a motorcycle, an airplane, or the like.

In one embodiment, the present invention provides a desk lamp with an authentic valve cover as the lamp shade. In another embodiment, the present invention provides a desk lamp with a replica of a valve cover as the lamp shade. In some embodiments of the present invention the wiring connections from the base of the desk lamp to the light source in the lamp shade are authentic spark plug wire casings with the appropriate lamp wiring inside. In other embodiments replicas of spark plug wires provide the wiring connections from the base of the desk lamp to the light source in the lamp shade. In some of the embodiments of the present invention the base of the desk lamp has a logo prominently displayed. This logo may represent a company, an event, a person, a publication, etc.

One aspect of the present invention is that it provides a vehicle-part themed device.

Another aspect of the present invention is that it provides a sales vehicle for promoting a brand through the use of brand recognizable shapes and logos.

Another aspect of the present invention is that it can utilize authentic or replica automotive parts.

Another aspect of the present invention is that it can be made of readily available materials.

Another aspect of the present invention is that it can be made inexpensively.

Another aspect of the present invention is that it is easy to use.

These and other features and advantages of the present invention will be presented in more detail in the following specification of the invention and the accompanying figures, which illustrate by way of example the principles of the invention.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention, together with further advantages thereof, may best be understood by reference to the following description taken in conjunction with the accompanying drawings in which:

FIG. 1 illustrates a perspective view of a desk lamp according to one embodiment of the present invention.

FIG. 2 illustrates a perspective view of a desk lamp according to another embodiment of the present invention.

FIG. 3 illustrates a perspective view of a desk lamp according to yet another embodiment of the present invention.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

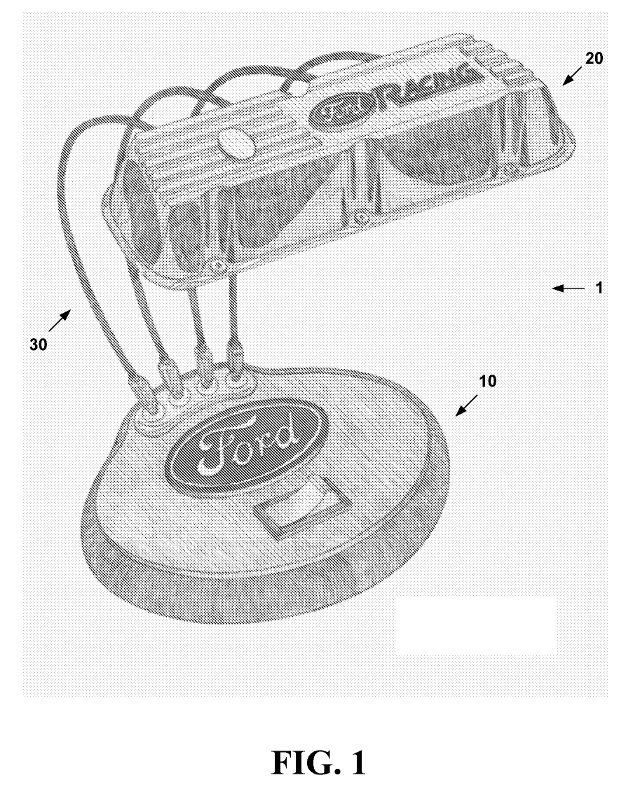

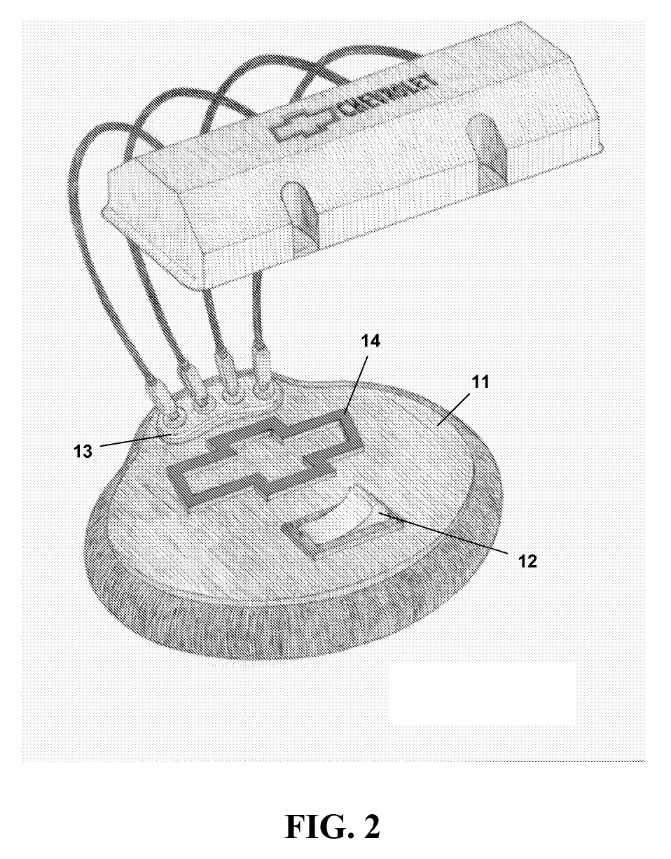

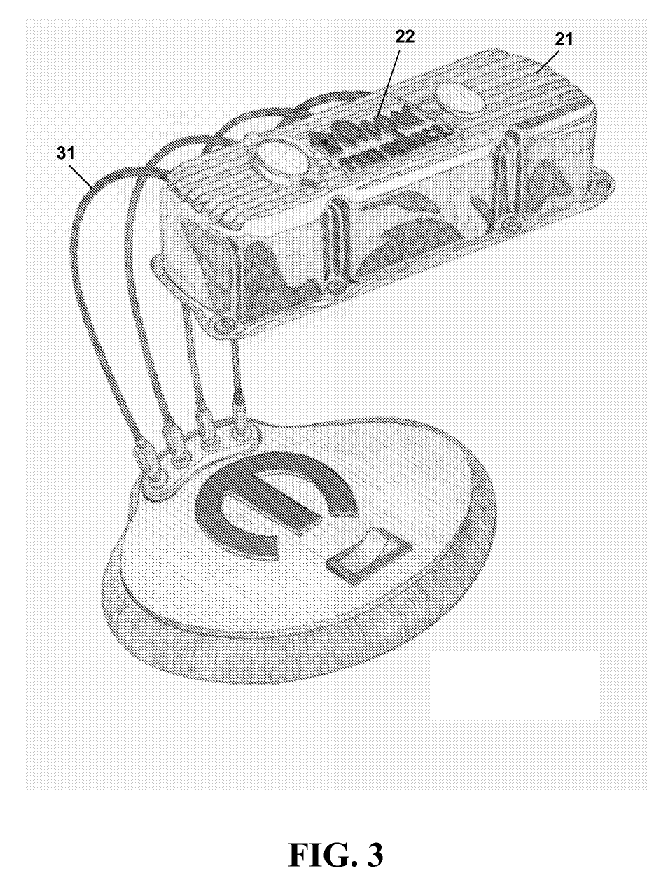

FIG. 1, FIG. 2, and FIG. 3 illustrate a perspective view of a desk lamp 1, according to several embodiments of the present invention.

Desk lamp 1 is comprised of base assembly 10, lamp shade assembly 20 and at least one of connector 30.

Base assembly 10 is comprised of a base 11, switch 12, connector support 13 and base logo 14. Base assembly 10 is further comprised of well known in the art parts for accessing and providing electrical power, e.g. an electrical plug, electrical wiring, electrical connections and components. Base 11 has a sufficient footprint and weight to provide stability.

Lamp shade assembly 20 is comprised of an automotive-part 21, at least one light source, and lamp shade logo 22. Lamp shade assembly 20 is further comprised of well known in the art parts for converting electrical power to visible light.

Connector 30 is comprised of an exterior casing 31. Connector 30 is further comprised of well known in the art wiring and components for securing connector 30 to base 11 through connector support 13, for securing connector 30 to lamp shade assembly 20, and for conducting electricity from the base assembly to the lamp assembly. In a preferred embodiment connector 30 is comprised of flexible conduit of a diameter to mimic sparkplug wires with rubber caps to conceal fastening methods and mimic spark plug caps. In another embodiment connector 30 is comprised of a substantially rigid conduit. Connector 30 is operable to attach to base 11 and to automotive-part 21.

In a preferred embodiment, there is four of connector 30, with automotive-part 21 being a replica of a valve cover to an engine, with exterior casing 31 being a replica of a spark plug wire outer casing, and with light source 22 being two 15W fluorescent tubes.

From the foregoing, it will be appreciated that, although specific embodiments of the invention have been described herein for purposes of illustration, various modifications may be made without deviating from the spirit and scope of the invention. For example, many of the features and components described above in the context of a particular vehicle-part configuration can be incorporated into other vehicle-part configurations in accordance with other embodiments of the invention. Accordingly, the invention is not limited except by the appended claims.

What is claimed is:

1. A vehicular-part themed desk lamp comprising:
a base assembly;
a lamp shade assembly; and
at least one connector, wherein the at least one connector operably attaches the base assembly to the lamp shade assembly and wherein the lamp shade assembly is an authentic automotive part.

2. The vehicular-part themed desk lamp as recited in claim 1, further comprising at least one first logo disposed on the base assembly.

3. The vehicular-part themed desk lamp as recited in claim 2, further comprising at least one second logo disposed on the lamp shade assembly.

4. The vehicular-themed desk lamp as recited in claim 3, wherein the at least one connector has an outer casing formed to resemble a spark plug wire.

5. The vehicular-themed desk lamp as recited in claim 4, wherein the lamp shade assembly is an engine valve cover.

6. The vehicular-themed desk lamp as recited in claim 5, wherein the engine valve cover is selected from the group comprising a car engine valve cover, a truck engine valve cover, a motorcycle valve cover.

7. A vehicular-part themed desk lamp comprising:
a base assembly;
a lamp shade assembly; and
at least one connector, wherein the at least one connector operably attaches the base assembly to the lamp shade assembly and wherein the lamp shade assembly is a replica of an automotive part.

8. The vehicular-part themed desk lamp as recited in claim 7, further comprising at least one first logo disposed on the base assembly.

9. The vehicular-part themed desk lamp as recited in claim 8, further comprising at least one second logo disposed on the lamp shade assembly.

10. The vehicular-themed desk lamp as recited in claim 9, wherein the at least one connector has an outer casing formed to resemble a spark plug wire.

11. The vehicular-themed desk lamp as recited in claim 10, wherein the lamp shade assembly is an engine valve cover.

12. The vehicular-themed desk lamp as recited in claim 11, wherein the engine valve cover is selected from the group comprising a car engine valve cover, a truck engine valve cover, a motorcycle valve cover.
